(19) United States
(12) Patent Application Publication
(10) Pub. No.: US 2016/0070460 A1
(43) Pub. Date: Mar. 10, 2016

(54) IN SITU ASSIGNMENT OF IMAGE ASSET ATTRIBUTES

(71) Applicant: Adobe Systems Incorporated, San Jose, CA (US)

(72) Inventors: Kai Gradert, Pasadena, CA (US); Klaas Stoeckmann, Hamburg (DE); Timothy Kukulski, Oakland, CA (US); Craig Scull, San Jose, CA (US); C Philip Clevenger, San Francisco, CA (US)

(73) Assignee: Adobe Systems Incorporated, San Jose, CA (US)

(21) Appl. No.: 14/477,466

(22) Filed: Sep. 4, 2014

(51) Int. Cl. G06F 3/0488; G06F 3/0482; G06F 17/30; G06F 3/0484

(52) U.S. Cl. CPC G06F 3/04883; G06F 3/0484; G06F 3/0482; G06F 17/3028

(57) ABSTRACT

Techniques are disclosed for assigning an attribute to an image asset. A touch-sensitive device can display images one at a time. Each image has a status attribute that indicates whether the image has been picked or rejected. The user can display and change the status of the displayed image using a vertical touch contact gesture. An upward gesture may be used to assign a picked status to an image asset or remove a rejected status from the image asset. A downward gesture may be used to assign a rejected status to the image asset or remove a picked status from the image asset. A user interface affordance is configured to display a flag graphic and text string corresponding to the current status of the image being displayed and an animated graphic in response to a vertical touch contact gesture for changing the status of the image asset.

### FIELD OF THE DISCLOSURE

This disclosure relates to the field of data processing, and more particularly, to techniques for assigning an attribute to an image asset displayed on a computing device, such as a device having a touch-sensitive screen.

### BACKGROUND

Photographers review photographs taken during a photo shoot to winnow down a typically large number of images into a smaller group of winners, or so-called heroes. When using analog film, the photographer develops the negatives and examines either the negatives themselves or contact sheets to identify the images of particular interest. With digital photography, image assets can be viewed either directly on the camera or using a computer-implemented image processing application, such as Adobe Lightroom or Adobe Camera Raw, after the image data has been transferred from the camera to the computer. However, prior techniques do not permit the photographer to assign a status to a displayed image in situ using a touch screen gesture.

### BRIEF DESCRIPTION OF THE DRAWINGS

The accompanying drawings are not intended to be drawn to scale. In the drawings, each identical or nearly identical component that is illustrated in various figures is represented by a like numeral.

FIG. 1 illustrates an example computing device for assigning an attribute to an image asset, in accordance with an embodiment of the present invention.

FIGS. 2A and 2B depict example graphical user interfaces for use in conjunction with the computing device of FIG. 1, in accordance with an embodiment of the present invention.

FIG. 3A depicts an example graphical user interface for assigning an attribute to an image asset, in accordance with an embodiment of the present invention.

FIG. 3B depicts a portion of the example graphical user interface of FIG. 3A in further detail.

FIGS. 3C, 3D and 3E depict the example graphical user interface of FIG. 3A in several different states of operation, in accordance with various embodiments of the present invention.

FIG. 4 is a flow diagram representative of an example methodology for assigning an attribute to an image asset, in accordance with an embodiment of the present invention.

FIGS. 5-7 are flow diagrams representative of several portions of the example methodology of FIG. 4 in further detail, in accordance with various embodiments of the present invention.

FIG. 8 is a block diagram representing an example computing system that may be used in accordance with an embodiment of the present invention.

FIG. 9 shows an example screenshot of a photographic image and user interface affordance in accordance with an embodiment of the present invention.

### DETAILED DESCRIPTION

As mentioned above, photographers often take many photographs from which relatively few are selected for use. The selection process can include simply marking each image as picked or rejected. However, when working with large numbers of images, this selection process can be very time consuming, particularly when the photographs are evaluated one at a time.

To this end, and in accordance with an embodiment of the present invention, techniques are disclosed for assigning, in situ, a status attribute to an image asset displayed on a computing device. Such computing devices can be, for example, devices having a touch-sensitive screen, including smart phones and tablets. The device can display images one at a time, and a user can browse through the images by swiping or gesturing horizontally (e.g., right to left or left to right) across the touch screen using a finger or stylus. The user may also use other gestures (e.g., pinching gestures) to zoom in or out on the displayed image. Each image has a status attribute for indicating whether the image has been picked or rejected by the user (or another user), once the status has been initially chosen. At any time, the user can view and change the status of the displayed image using a vertical touch contact gesture. For example, an upward touch contact gesture may be used to assign a picked status to an image asset, remove a rejected status from the image asset, or both. Similarly, a downward touch contact gesture may be used to assign a rejected status to the image asset, remove a picked status from the image asset, or both. Regardless of which gesture (upward or downward) is used, any touch contact can invoke a user interface (UI) affordance configured to display the status and available choices that can be selected by the user via a touch contact gesture. By their design, touch-sensitive devices facilitate direct interaction with content, as opposed to indirect interaction using an input device such as a mouse or keyboard, thereby affording a solution that allows the user to quickly assign a status to an image using a single gesture on a touch-sensitive screen while the image is being displayed. Numerous configurations and variations will be apparent in light of this disclosure. For example, embodiments can be used in conjunction with any touch-sensitive device for any applications having flagging attributes.

As used in this disclosure, the term “in situ” refers to requesting or commanding performance of a function, such as assigning a status attribute, using an input applied to a device displaying an object, such as an image, upon which the function is to be performed. For example, a pick or reject function may be performed by applying a flick-like or swipe-like gesture to a touch-sensitive screen displaying an image without separately invoking a user interface or chrome prior to performing the flick-like or swipe like gesture. As used in this disclosure, the term “chrome” refers to visible features of a graphical user interface (e.g., text, icons, cursors, buttons, checkboxes, sliders, frames, windows, interactive widgets, or other visible user interface elements).

As used in this disclosure, the term “UI affordance” refers to a visual representation of a functional object within the user interface of the device. The UI affordance may, for example, have a circular form (or other regular shape) in the center of the touch-sensitive screen (or other location) containing a flag graphic and a text string. The status of any given image asset can be “picked,” “rejected” or unassigned (e.g., null), or any other suitable qualifier. The UI affordance is configured to display the flag graphic and text string corresponding to the current status of the image asset being displayed, as well as to display an animated graphic in response to a vertical touch contact gesture for changing the status of the image asset, in accordance with an embodiment.

In one particular embodiment, the UI affordance is revealed to the user on the display when a single touch contact (e.g., one finger only) or vertical gesture is detected in situ with a displayed image. No other user interface or chrome is used prior to revealing the UI affordance. The vertical gesture results from a user touching the screen with a single finger and flicking or swiping the finger substantially upwards or downwards with respect to the screen orientation (e.g., portrait or landscape). A substantially vertical gesture may, for example, be one in which the vertical component of the gesture is larger than the horizontal component, if any. Once the UI affordance is revealed, the current status of the displayed image asset, if any, is shown in the affordance as a picked flag or rejected flag, respectively. If the status is unassigned, the UI affordance displays a suitable graphic or text string (e.g., “unassigned” or “unflag”). As the distance of the gesture increases (e.g., as the user continues to swipe the finger across the screen in a continuous vertical motion), the UI affordance is animated to display the status that will be selected if the user ends the touch contact at the current screen position (e.g., by lifting the finger off of the screen). For example, an upwards gesture may cause the UI affordance to display “Pick” and a flag with a checkmark icon (representing a picked status) if there is no status currently assigned to the image asset or if the current status is rejected, or to display “Unflag” if the current status of the image asset is rejected. Similarly, a downward gesture may cause the UI affordance to display “Reject” and a flag with a cross icon (representing a rejected status) if there is no status currently assigned to the image asset or if the current status is picked, or display “Unflag” if the current status of the image asset is picked. Visually this may appear on the screen to behave like a slot machine. For instance, the circular window of the UI affordance can display at least three states: picked, unassigned and rejected. The visual transitions between those three states occur similarly to a slot machine with lemons and limes and jackpots, with corresponding graphics that vertically scroll in and out of view and the various states move in response to the corresponding vertical gesture. Other types and forms of UI affordances will be apparent in light of this disclosure.

Example System

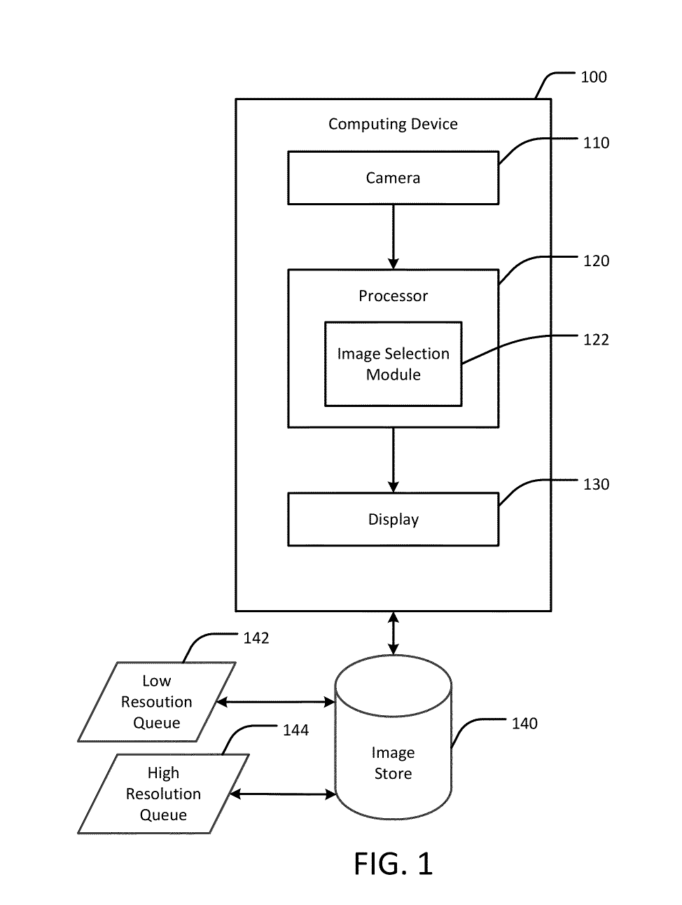

FIG. 1 illustrates an example computing device 100 for assigning an attribute to an image asset displayed on the computing device, in accordance with an embodiment. The device 100 includes a camera 110, a processor 120, and a display 130. Generally, the device 100 can include any type of computing device, such as a personal computer (PC), tablet, or smart phone. The processor can include an image selection module 122 for processing image data, as will be discussed in further detail below. It will be understood that the camera 110, processor 120 and display 130 can be integrated into a single device or into several devices (e.g., the camera 110 may be a separate Universal Serial Bus (USB) camera connected to the computing device 100, or the display 130 may be a standalone computer monitor connected to the computing device 100). In some embodiments, the display 130 includes a touch-sensitive screen that is configured to detect a contact between a user's finger or a stylus and the surface of the screen, and the location and movement of such screen contact.

By way of example, the camera 110 can be configured to obtain a plurality of images and send each image frame to the processor 120. The processor 120 in turn can send one or more of the images to the display 130 so that a user can view the images. Additionally or alternatively, the processor 120 can send one or more of the images to an image store 140 or other suitable memory for storage and subsequent retrieval. The image store 140 may be an internal memory of the computing device 100 or an external database (e.g., a server-based database) accessible via a wired or wireless communication network, such as the Internet. The image store 140 can contain a low resolution queue 142 and a high resolution queue 144 for storing low and high resolution versions of the images, respectively.

Example Use Cases

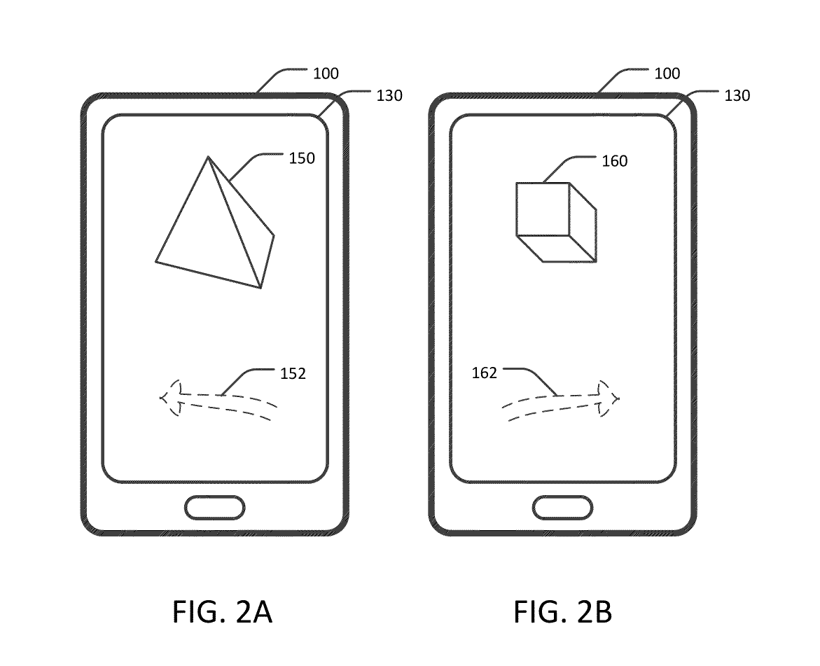

FIGS. 2A and 2B depict example graphical user interfaces for use in conjunction with the computing device 100 of FIG. 1, in accordance with an embodiment. FIG. 2A depicts the computing device 100 showing a first image 150 on the display 130, and FIG. 2B depicts the computing device 100 showing a second image 160 on the display 130. The first and second images 150, 160 may be stored in, and retrieved from, the image store 140 of FIG. 1. A leftward, horizontal touch contact gesture input 152 can be used to command the computing device 100 to switch from displaying the first image 150 (FIG. 2A) to displaying the second image 160 (FIG. 2B). Likewise, a rightward, horizontal touch contact gesture input 162 can be used to command the computing device 100 to switch from displaying the second image 160 to displaying the first image 150. It will be understood that any number of images can be displayed in this manner by continually swiping horizontally in one direction or the other. In this example, the computing device 100 displays one image at a time.

In some embodiments, at least two image queues can be used for staging the first and second images 150, 160 (and any other images) in memory for display: a low resolution queue and a high resolution queue, such as the queues 142, 144 described with respect to FIG. 1. Initially, a low resolution version of each image 150, 160 can be loaded into the low resolution queue, which enables the device to quickly display the low resolution versions as the user swipes between each image. If a user dwells on any one of the images 150, 160 for a predetermined period of time (e.g., one second, two seconds, three seconds, etc.), then a high resolution version of the displayed image can be generated, loaded into the high resolution queue and displayed to the user. Similarly, as processing resources permit, high resolution versions of each image 150, 160 can be generated and loaded in the high resolution queue 144 for immediate display when the user swipes to display them, bypassing the display of the low resolution image in the low resolution queue 142. In this manner, the user can quickly preview each of the images 150, 160 at low resolution if high resolution versions of these images have not yet been generated and placed into the high resolution queue 144.

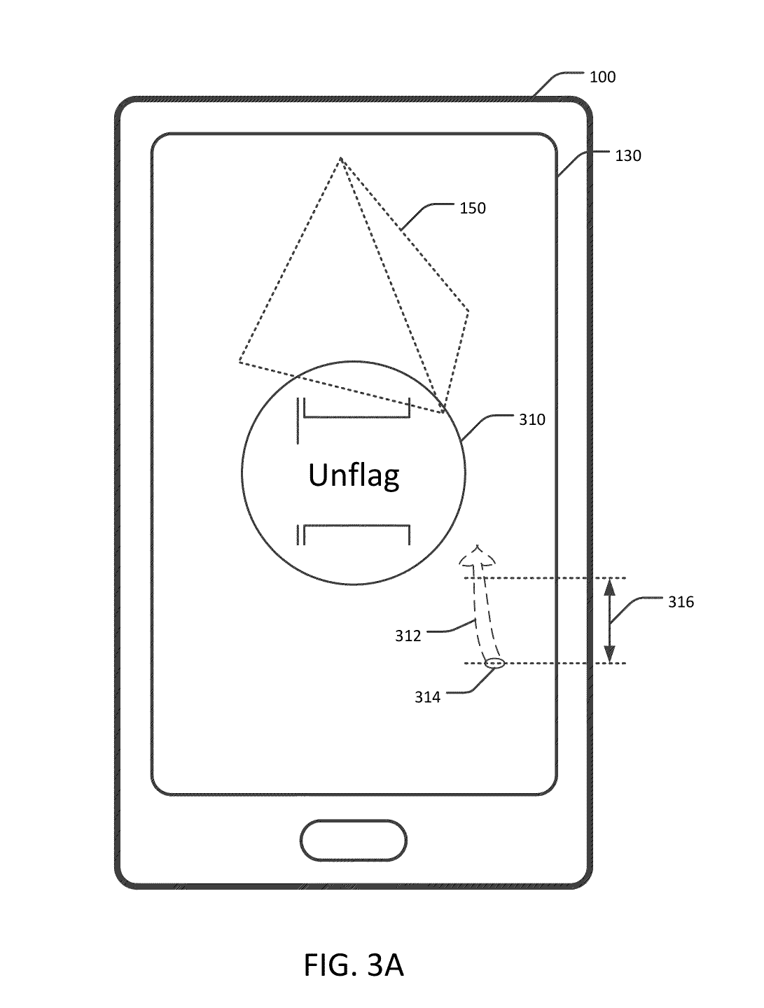

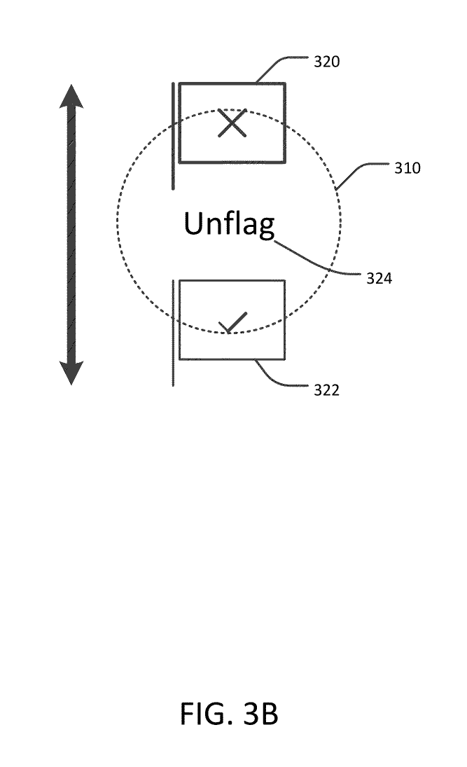

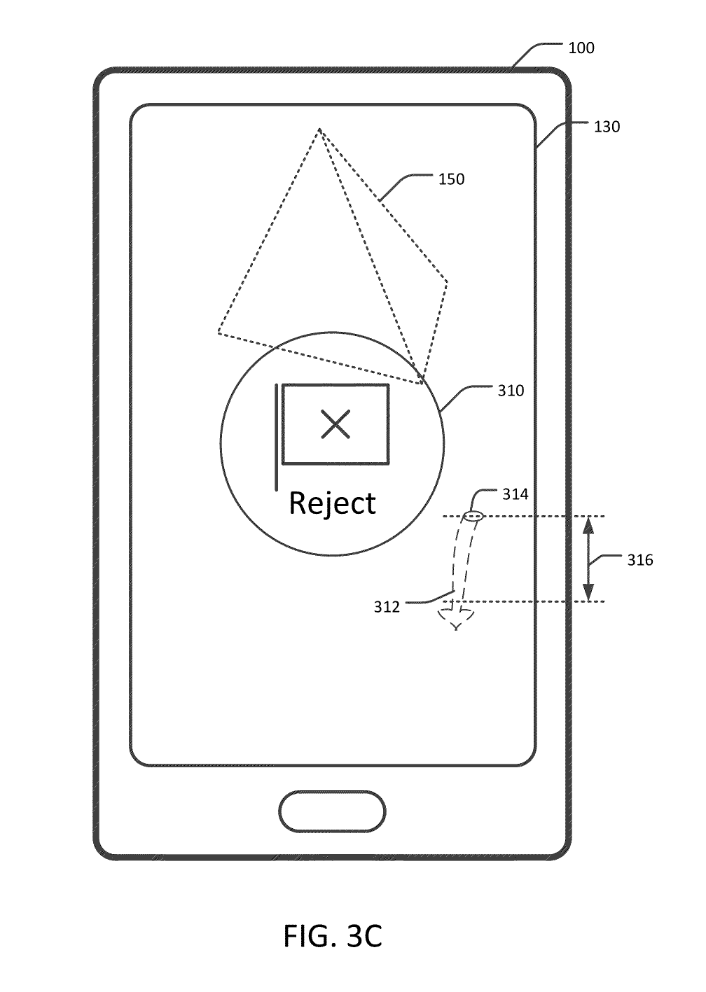

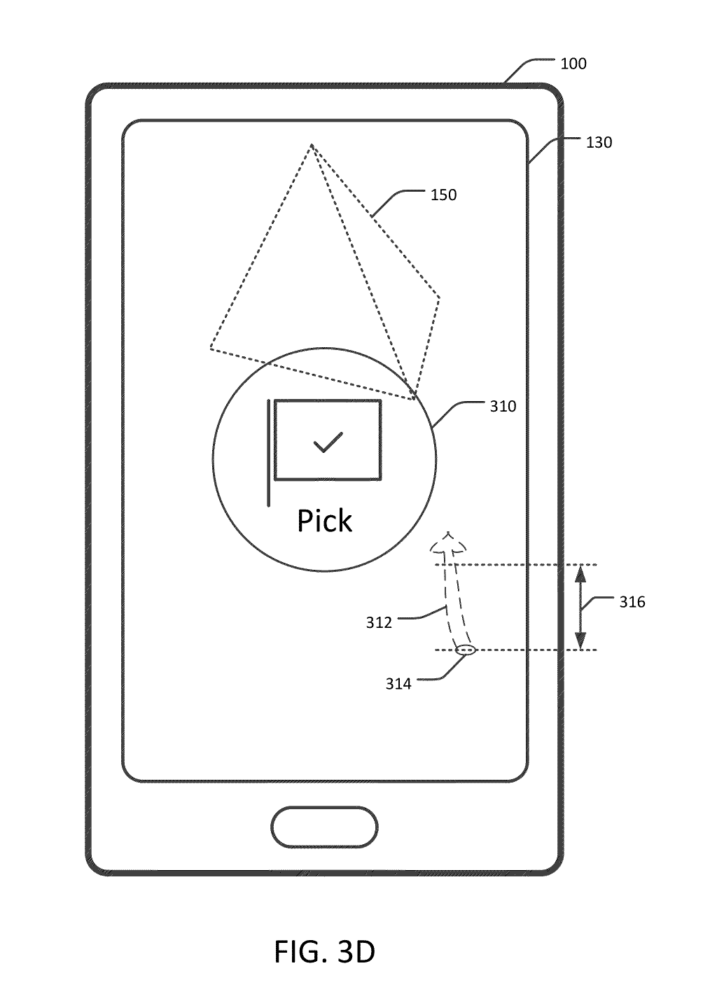

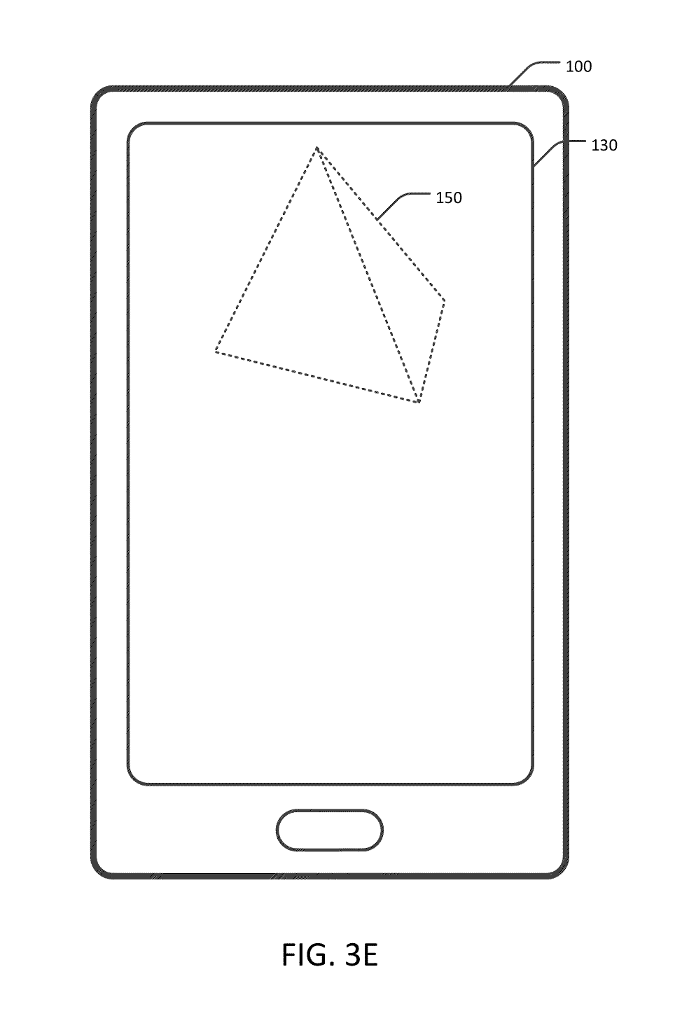

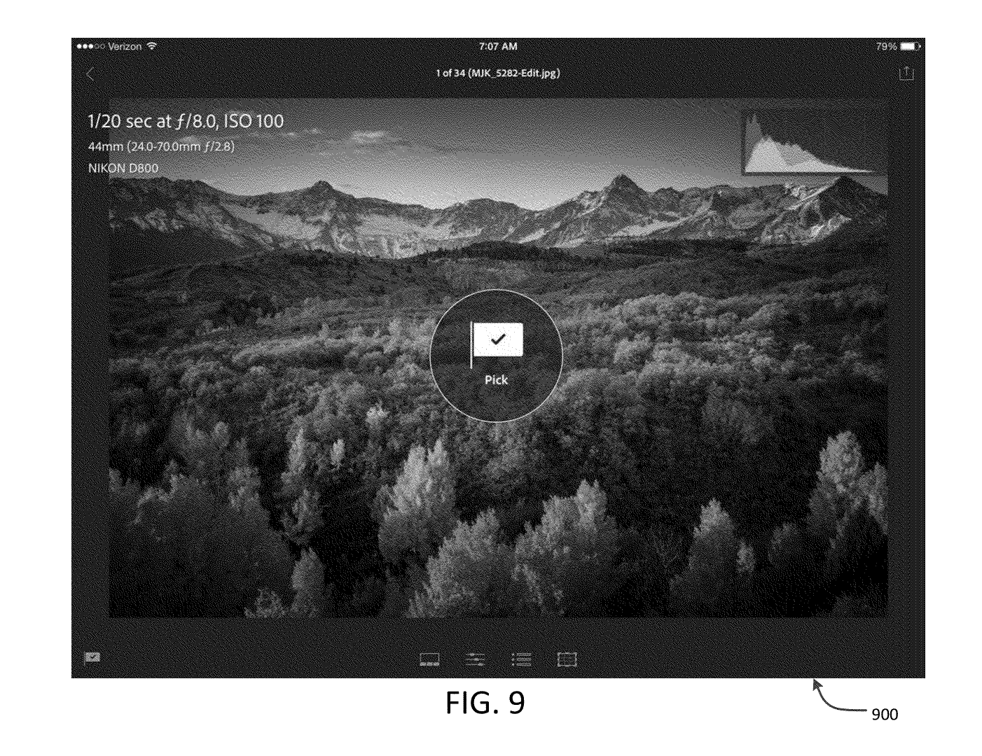

FIG. 3A depicts an example graphical user interface for assigning an attribute to an image asset, in accordance with an embodiment. By contrast with the horizontal gestures described above with respect to FIGS. 2A and 2B, in FIG. 3A a vertical touch contact gesture input 312 causes the computing device 100 to reveal a UI affordance 310 on the display 130. It will be understood that in various embodiments, it is not necessary to activate or display any particular user interface prior to revealing the UI affordance 310. The vertical contact gesture input 312 can be an upward gesture or a downward gesture applied to the display 130 while the image 150 is displayed. Furthermore, the speed of the vertical contact gesture input 312 can represent a quick, flick-like gesture or a gradual, swipe-like gesture. The UI affordance 310, once revealed, is configured to display a visual indication of the current status attribute, or state, associated with the displayed image 150. FIG. 9 shows an example screenshot 900 of a photographic image and UI affordance in accordance with an embodiment, although it will be understood that any type of image or other information (e.g., any type of visually represented information, such as text, graphics, documents, or any type of audibly represented information, such as music, tones, voice recordings, etc.) may be used in addition to or in place of the image. The status attribute, which represents a state, may be, for example, picked, unassigned, rejected, accepted, flagged, unflagged, thumbs-up, thumbs-down, tagged, untagged, or any other characteristic that can be assigned to the displayed image 150. In some cases, the UI affordance 310 is superimposed over the image 150, such as shown in the example of FIG. 9. When using a swipe-like gesture, the UI affordance becomes animated in a slot machine fashion to show other status indicators that can be selected, such as picked and rejected, as the user increases the length of the vertical contact gesture input 312 from an initial point 314. When using a flick-like gesture, the UI affordance is not animated but rather immediately shows a status indicator, such as picked or rejected, that corresponds to the direction of the gesture (e.g., an upward flick gesture selects picked, and a downward flick gesture selects rejected). FIG. 3B shows each of three possible status indicators: rejected 320, unassigned 324 and picked 322. These status indicators are animated to slide vertically as the distance of the vertical contact gesture input 312 increases or decreases from the initial point 314. As shown in FIG. 3A, only the portions of the status indicators falling within the UI affordance 310 will be shown, and the remainder hidden from view as they slide into and out of the region indicated at 310. For example, if the user begins to gesture upwards, the UI affordance 310 may initially display “Unflag” and transition, via a sliding animation, to reveal the picked flag 322 as the user continues to swipe or drag the finger upwards. Likewise, the UI affordance 310 may initially display “Unflag” and transition, via a sliding animation, to reveal the rejected flag 320 as the user continues to swipe or drag the finger downwards. In some cases, the amount and speed of the transition animation from one status indicator to another shown in the UI affordance 310 is a function of the distance and speed of the gesture 312 relative to the initial point 314. This creates the illusion of controlling the status attribute in real time according to the direction and speed of movement of the touch input.

If the vertical contact gesture input 312 exceeds a predetermined distance threshold 316 (e.g., the distance between the initial point 314 and the end point of the touch contact is greater than the threshold), the UI affordance 310 displays the corresponding status indicator 312, 314 or 316. For example, as shown in FIG. 3C, if the current status of the image 150 is unassigned or unflagged, and a downward gesture 312 exceeds the threshold distance 316 when the touch contact input ends (e.g., the user removes the finger), then the UI affordance 310 displays the rejected flag 320. Likewise, as shown in FIG. 3D, if the current status of the image 150 is unassigned or unflagged, and an upward gesture 312 exceeds the threshold distance 316 when the touch contact input ends (e.g., the user removes the finger), then the UI affordance 310 displays the picked flag 312. The threshold distance 316 may, for example, be measured in pixels (e.g., ten pixels, 100 pixels, 250 pixels, etc.).

Shortly after the gesture 312 ends, the UI affordance 310 may briefly display a confirmatory animation (e.g., a bubbling zoom-like animation of the visible flag and text) before disappearing from the display 130, leaving only the image 150 visible. The status of the displayed image 150 selected by the vertical gesture persists in memory or the image store 140. At this point, the user can again change the status of the image 150 using a vertical gesture, or select a different image, such as by using the horizontal swipe gestures 152 and 162 described above with respect to FIGS. 2A and 2B.

Example Methodology

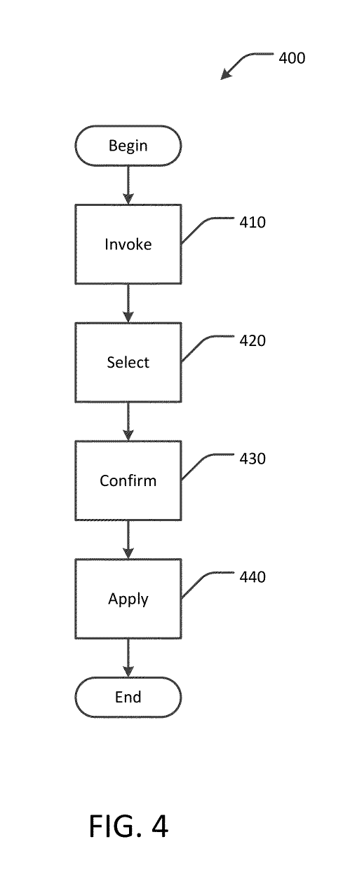

FIG. 4 is a flow diagram of an example methodology 400 for assigning an attribute to an image asset displayed on a computing device, in accordance with an embodiment. The example methodology 400 may, for example, be implemented by the image selection module 122 of FIG. 1. The methodology 400 includes four phases of operation: invoking 410, selecting 420, confirming 430 and applying 440. During the invoking phase 410, a determination is made whether the user is gesturing on a touch-sensitive screen to invoke a UI affordance, such as the UI affordance 310 of FIG. 3A, for an image that is currently displayed (e.g., via the display 130 of FIG. 1). If the user is gesturing to invoke the UI affordance, the UI affordance is displayed during the selecting phase 420. During the selecting phase 420, the UI affordance is used to provide visual feedback to the user as the user gestures upward or downward to select the status of the displayed image. Once the gesture ends, the UI affordance provides a visual confirmation of a change, or lack of change, in the selected status of the displayed image during the confirming phase 430. During the applying phase 440, the status of the displayed image is updated to reflect the status selected by the user during the selecting phase 420.

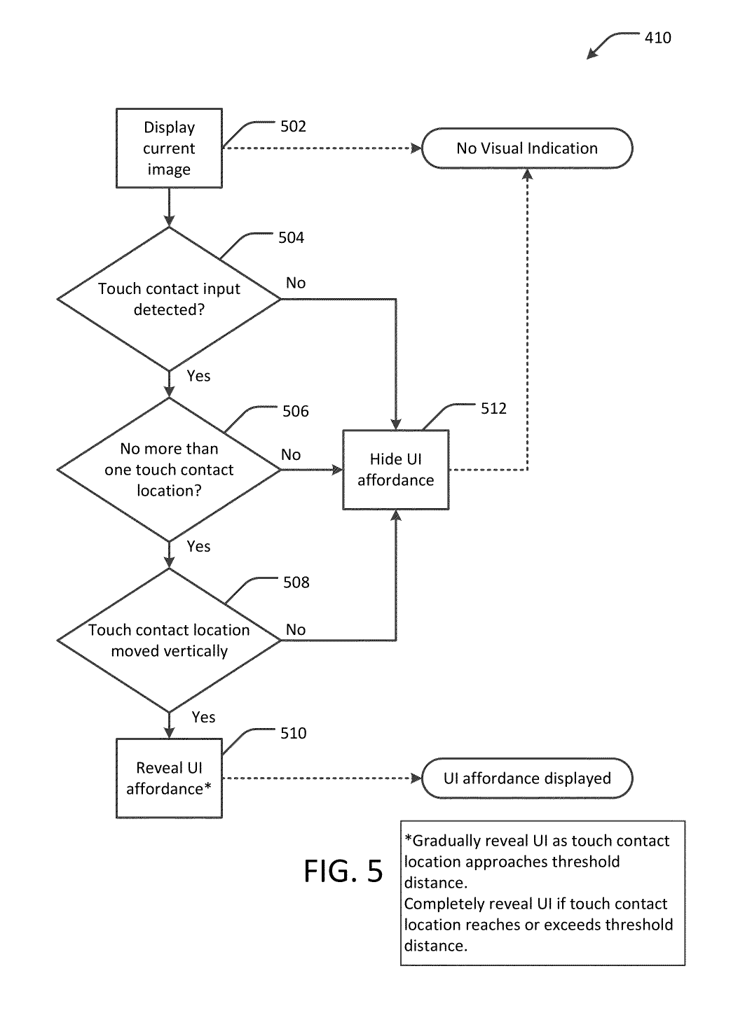

FIG. 5 is a flow diagram representing a portion of the example methodology 400 of FIG. 4, in accordance with an embodiment. In particular, FIG. 5 depicts the invoking phase 410 in further detail. After the current image is displayed 502, if a touch contact input (e.g., a touch contact with the display 130 of FIG. 1) is detected 504, and there is no more than one touch contact location 506 (e.g., there is only one finger touching the screen), and the touch contact location has moved vertically 508, then the UI affordance is revealed 510. Otherwise, the UI affordance is hidden 512 and the invoking phase 410 begins again. In some cases, the UI affordance is gradually revealed as the touch contact location approaches a threshold distance from an initial point of touch contact, such as described with respect to FIG. 3A. For example, the UI affordance may appear to fade into view as the gesture approaches the threshold distance or fade out of view as the gesture retreats away from the threshold distance. Further, once the gesture has reached or exceeded the threshold distance, the UI affordance may be completely displayed.

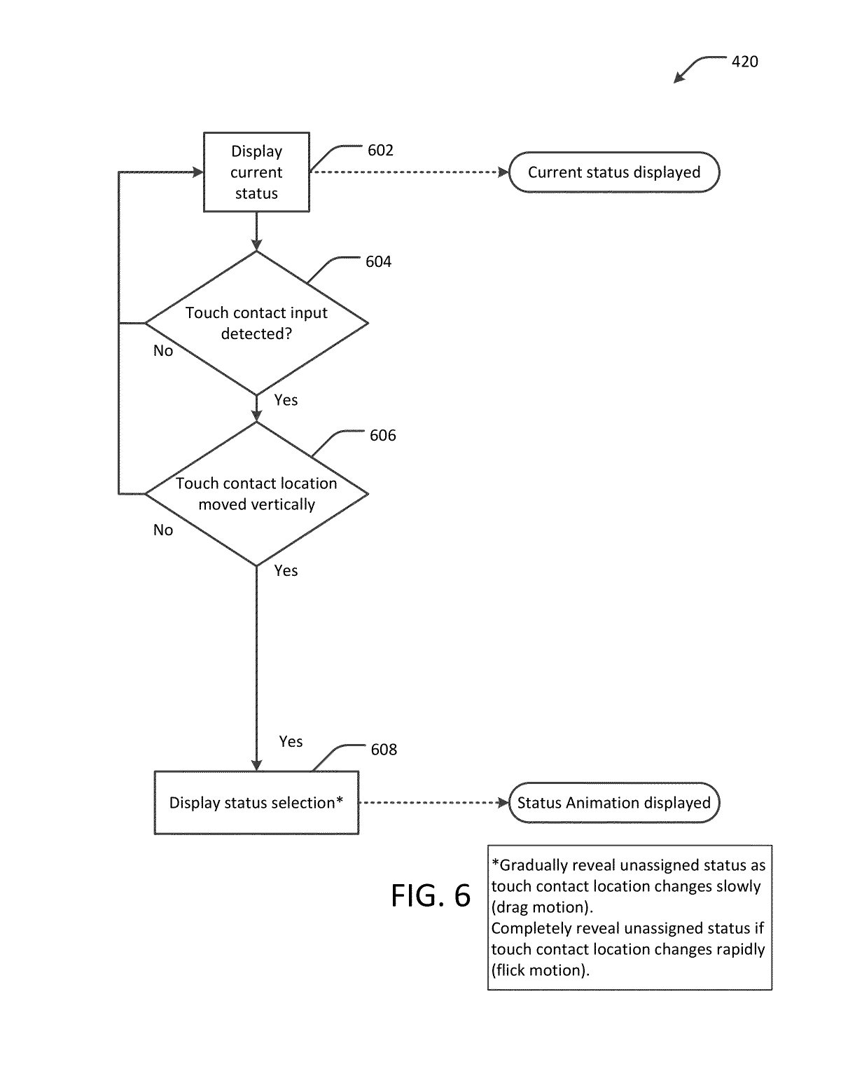

FIG. 6 is a flow diagram representing another portion of the example methodology of FIG. 4, in accordance with an embodiment. In particular, FIG. 6 depicts the selecting phase 420 in further detail. Once the UI affordance is displayed (e.g., as per the invoking phase 410), the current status of the displayed image, if any, is displayed 602. If no status is assigned to the displayed image, the UI affordance displays a default value, such as unflagged or unassigned. If the touch contact input continues to be detected 604, and as the gesture continues to move vertically 606, the UI affordance displays 608 the status selection, such as described with respect to FIGS. 3B and 3C. For example, if the current status is unassigned, then as the user continues to gesture in either the upward or downward directions, the UI affordance animates the available status selections in a slot machine fashion.

In one embodiment, if the speed at which the touch contact location moves vertically is fast (e.g., resulting from a flick motion), then the slot machine animation is similarly performed quickly in the direction of motion. Likewise, if the speed at which the touch contact location moves vertically is slow (e.g., resulting from a swipe motion), then the slot machine animation is similarly performed slowly in the direction of motion and commensurate with the speed at which the user is applying the gesture to the touch screen. In this manner, a user can quickly select a status by making a rapid flick gesture, or more slowly select the status by making a gradual swipe gesture. In the case where the user is making a gradual swipe gesture, the user has the option of canceling the status selection by swiping in the opposite direction or by ending the touch contact before the threshold distance has been reached from the initial contact location.

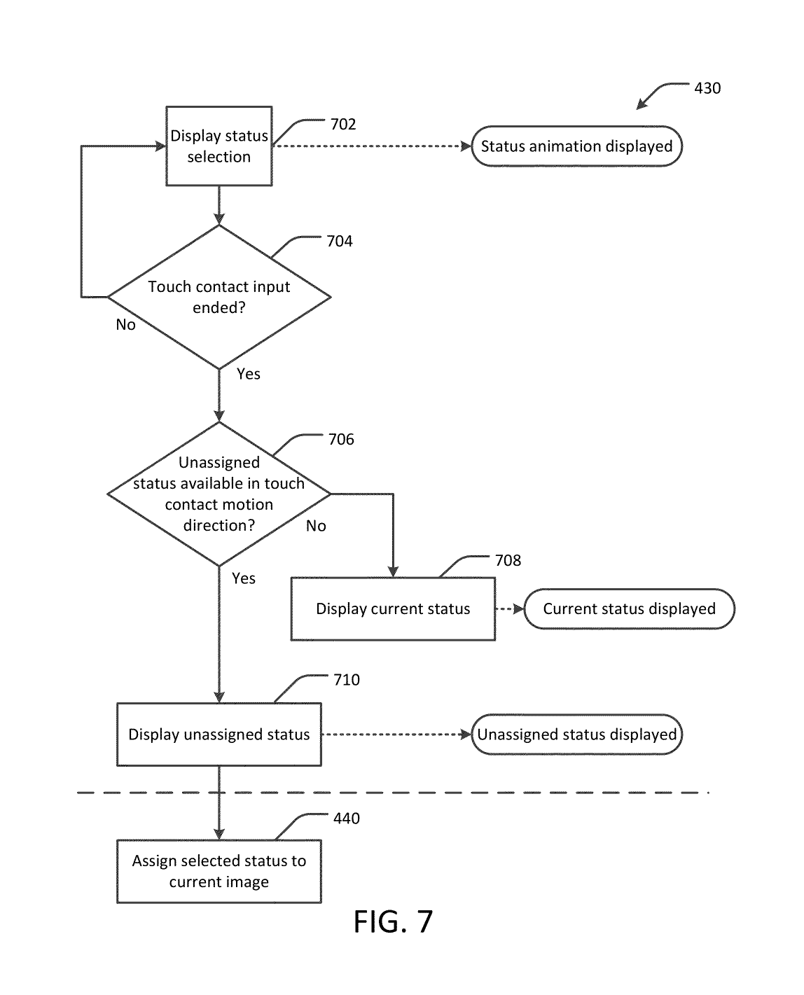

FIG. 7 is a flow diagram representing another portion of the example methodology of FIG. 4, in accordance with an embodiment. In particular, FIG. 7 depicts the confirming and applying phases 430, 440 in further detail. As noted above, once the user has selected a status using a vertical touch contact gesture, that status selection associated with the direction of gesture motion is displayed 702. When the touch contact input ends 704, a determination is made as to whether the selected status selection is available for assignment to the displayed image asset. If, for example, the user has selected a currently unassigned status (e.g., if the current status is rejected and the selected status is picked, or vice versa), then the selected status is displayed 710 and assigned 440 to the currently displayed image. Otherwise, the current status of the image is displayed 708 and the status is unchanged. The status attribute associated with the displayed image is persistent and available to any recipient of the image, such as via filtered lists via database queries. The image may conditionally display a non-obtrusive visual icon reflecting its current status (e.g., picked or rejected).

In one embodiment, if the speed at which the touch contact location moves vertically is fast (e.g., resulting from a flick motion) and the touch contact input ends 704, and an unassigned status is available, then the selected status is displayed 710 in the center of the UI affordance with a bubbling zoom-like animation. If, on the other hand, the unassigned status is unavailable (e.g., the user is swiping in a direction for which there is no selection available), the current status of the image is displayed 708 in the center of the UI affordance with a bubbling zoom-like animation. Likewise, if the speed at which the touch contact location moves vertically is slow (e.g., resulting from a swipe motion) and the touch contact location input ends 704 at or beyond a threshold distance from the initial contact location, and an unassigned status is available, then the selected status is displayed 710 in the center of the UI affordance with a bubbling zoom-like animation. If, on the other hand, the unassigned status is unavailable, the current status of the image is displayed 708 in the center of the UI affordance without a bubbling zoom-like animation.

Example Computing Device

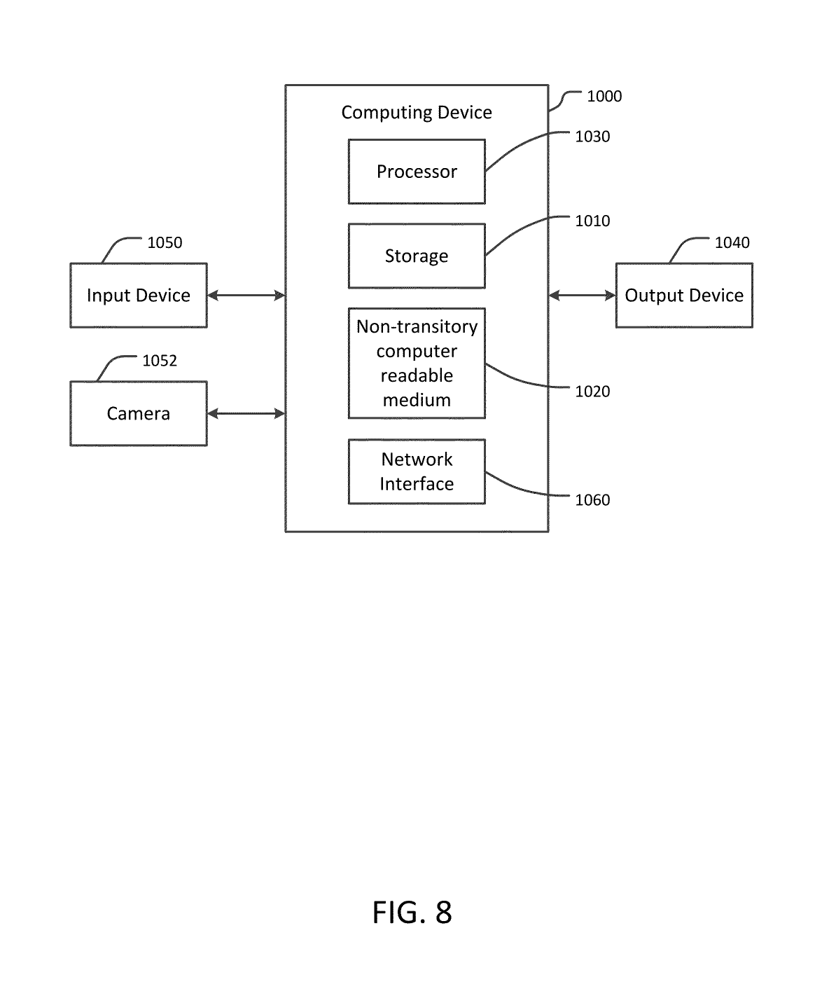

FIG. 8 is a block diagram representing an example computing device 1000 that may be used to perform any of the techniques as variously described in this disclosure. For example, the computing device 100, the camera 110, the processor 120, the display 130, the image selection module 122, or any combination of these may be implemented in the computing device 1000. The computing device 1000 may be any computer system, such as a workstation, desktop computer, server, laptop, handheld computer, tablet computer (e.g., the iPad™ tablet computer), mobile computing or communication device (e.g., the iPhone™ mobile communication device, the Android™ mobile communication device, and the like), or other form of computing or telecommunications device that is capable of communication and that has sufficient processor power and memory capacity to perform the operations described in this disclosure. A distributed computational system may be provided comprising a plurality of such computing devices.

The computing device 1000 includes one or more storage devices 1010 and/or non-transitory computer-readable media 1020 having encoded thereon one or more computer-executable instructions or software for implementing techniques as variously described in this disclosure. The storage devices 1010 may include a computer system memory or random access memory, such as a durable disk storage (which may include any suitable optical or magnetic durable storage device, e.g., RAM, ROM, Flash, USB drive, or other semiconductor-based storage medium), a hard-drive, CD-ROM, or other computer readable media, for storing data and computer-readable instructions and/or software that implement various embodiments as taught in this disclosure. The storage device 1010 may include other types of memory as well, or combinations thereof. The storage device 1010 may be provided on the computing device 1000 or provided separately or remotely from the computing device 1000. The non-transitory computer-readable media 1020 may include, but are not limited to, one or more types of hardware memory, non-transitory tangible media (for example, one or more magnetic storage disks, one or more optical disks, one or more USB flash drives), and the like. The non-transitory computer-readable media 1020 included in the computing device 1000 may store computer-readable and computer-executable instructions or software for implementing various embodiments. The computer-readable media 1020 may be provided on the computing device 1000 or provided separately or remotely from the computing device 1000.

The computing device 1000 also includes at least one processor 1030 for executing computer-readable and computer-executable instructions or software stored in the storage device 1010 and/or non-transitory computer-readable media 1020 and other programs for controlling system hardware. Virtualization may be employed in the computing device 1000 so that infrastructure and resources in the computing device 1000 may be shared dynamically. For example, a virtual machine may be provided to handle a process running on multiple processors so that the process appears to be using only one computing resource rather than multiple computing resources. Multiple virtual machines may also be used with one processor.

A user may interact with the computing device 1000 through an output device 1040, such as a screen or monitor (e.g., the touch-sensitive display 130 of FIG. 1), which may display one or more user interfaces provided in accordance with some embodiments. The output device 1040 may also display other aspects, elements and/or information or data associated with some embodiments. The computing device 1000 may include other I/O devices 1050 for receiving input from a user, for example, a keyboard, a joystick, a game controller, a pointing device (e.g., a mouse, a user's finger interfacing directly with a display device, etc.), or any suitable user interface. The computing device 1000 may include other suitable conventional I/O peripherals, such as a camera 1052. The computing device 1000 can include and/or be operatively coupled to various suitable devices for performing one or more of the functions as variously described in this disclosure.

The computing device 1000 may run any operating system, such as any of the versions of Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device 1000 and performing the operations described in this disclosure. In an embodiment, the operating system may be run on one or more cloud machine instances.

In other embodiments, the functional components/modules may be implemented with hardware, such as gate level logic (e.g., FPGA) or a purpose-built semiconductor (e.g., ASIC). Still other embodiments may be implemented with a microcontroller having a number of input/output ports for receiving and outputting data, and a number of embedded routines for carrying out the functionality described in this disclosure. In a more general sense, any suitable combination of hardware, software, and firmware can be used, as will be apparent.

As will be appreciated in light of this disclosure, the various modules and components of the system shown in FIG. 1, such as the image selection module 122, can be implemented in software, such as a set of instructions (e.g., C, C++, object-oriented C, JavaScript, Java, BASIC, etc.) encoded on any computer readable medium or computer program product (e.g., hard drive, server, disc, or other suitable non-transient memory or set of memories), that when executed by one or more processors, cause the various methodologies provided in this disclosure to be carried out. It will be appreciated that, in some embodiments, various functions performed by the user computing system, as described in this disclosure, can be performed by similar processors and/or databases in different configurations and arrangements, and that the depicted embodiments are not intended to be limiting. Various components of this example embodiment, including the computing device 100, can be integrated into, for example, one or more desktop or laptop computers, workstations, tablets, smartphones, game consoles, set-top boxes, or other such computing devices. Other componentry and modules typical of a computing system, such as processors (e.g., central processing unit and co-processor, graphics processor, etc.), input devices (e.g., keyboard, mouse, touch pad, touch screen, etc.), and operating system, are not shown but will be readily apparent.

Numerous embodiments will be apparent in light of the present disclosure, and features described in this disclosure can be combined in any number of configurations. One example embodiment provides a system including a storage having at least one memory, and one or more processors each operatively coupled to the storage. The one or more processors are configured to carry out a process including displaying an image on a display device, the image having a status attribute associated therewith, the status attribute representing one of a plurality of states; detecting a touch contact input via a touch-sensitive input device; invoking a user interface affordance in response to the touch contact input, the user interface affordance configured to provide a visual indication of the plurality of states on the display device; receiving a user selection of one of the plurality of states via the user interface affordance based on the same touch contact input; providing a visual confirmation of the user selection via the user interface affordance on the display device; and assigning the state associated with the user selection to the status attribute. In some embodiments, the touch contact input includes a vertical touch gesture, and the invoking of the user interface affordance further comprises displaying the user interface affordance on the display device. In some such embodiments, the user interface affordance is completely displayed subsequent to the vertical touch gesture reaching or exceeding a threshold distance away from an initial touch contact location. In some other such embodiments, the user interface affordance is gradually displayed as a function of a distance the vertical touch gesture moves away from an initial touch contact location. In yet some other such embodiments, the visual indication of the plurality of states includes an animation of each of the plurality of states moving as a function of a distance the vertical touch gesture moves away from an initial touch contact location. In some embodiments, the process includes detecting an end of the touch contact input via the touch-sensitive input device, where the providing of the visual confirmation of the user selection occurs in response to the end of the touch contact input. In some such embodiments, the visual confirmation includes an animation. In some embodiments, the displayed image is a low resolution version of the image stored in a low resolution image queue, where the process includes rendering a high resolution version of the image to be stored in a high resolution image queue, and where the displayed image is changed to the high resolution version of the image after the image has been rendered. In some embodiments, the touch contact input includes a flick touch gesture or a swipe touch gesture. In some such embodiments, the user interface affordance is completely displayed subsequent to the flick touch gesture or subsequent to the swipe touch gesture. Another embodiment provides a non-transient computer-readable medium or computer program product having instructions encoded thereon that when executed by one or more processors cause the processor to perform one or more of the functions defined in the present disclosure, such as the methodologies variously described in this paragraph. As previously discussed, in some cases, some or all of the functions variously described in this paragraph can be performed in any order and at any time by one or more different processors.

The foregoing description and drawings of various embodiments are presented by way of example only. These examples are not intended to be exhaustive or to limit the invention to the precise forms disclosed. Alterations, modifications, and variations will be apparent in light of this disclosure and are intended to be within the scope of the invention as set forth in the claims.

What is claimed is:

1. A computer-implemented digital image processing method comprising:
displaying an image on a display device, the image having a status attribute associated therewith, the status attribute representing one of a plurality of states;
detecting a touch contact input via a touch-sensitive input device;
invoking a user interface affordance in response to the touch contact input, the user interface affordance configured to provide a visual indication of the plurality of states on the display device;
receiving a user selection of one of the plurality of states via the user interface affordance based on the same touch contact input;
providing a visual confirmation of the user selection via the user interface affordance on the display device; and
assigning the state associated with the user selection to the status attribute.

2. The method of claim 1, wherein the touch contact input includes a vertical touch gesture, and wherein the invoking of the user interface affordance further comprises displaying the user interface affordance on the display device.

3. The method of claim 2, wherein the user interface affordance is completely displayed subsequent to the vertical touch gesture reaching or exceeding a threshold distance away from an initial touch contact location.

4. The method of claim 2, wherein the user interface affordance is gradually displayed as a function of a distance the vertical touch gesture moves away from an initial touch contact location.

5. The method of claim 2, wherein the visual indication of the plurality of states includes an animation of each of the plurality of states moving as a function of a distance the vertical touch gesture moves away from an initial touch contact location.

6. The method of claim 1, further comprising detecting an end of the touch contact input via the touch-sensitive input device, wherein the providing of the visual confirmation of the user selection occurs in response to the end of the touch contact input.

7. The method of claim 6, wherein the visual confirmation includes an animation.

8. The method of claim 1, wherein the displayed image is a low resolution version of the image stored in a low resolution image queue, wherein the method further comprises rendering a high resolution version of the image to be stored in a high resolution image queue, and wherein the displayed image is changed to the high resolution version of the image after the image has been rendered.

9. A system comprising:
a storage;
a processor operatively coupled to the storage, the processor configured to execute instructions stored in the storage that when executed cause the processor to carry out a process comprising:
displaying an image on a display device, the image having a status attribute associated therewith, the status attribute representing one of a plurality of states;
detecting a touch contact input via a touch-sensitive input device;
invoking a user interface affordance in response to the touch contact input, the user interface affordance configured to provide a visual indication of the plurality of states on the display device;
receiving a user selection of one of the plurality of states via the user interface affordance based on the same touch contact input;
providing a visual confirmation of the user selection via the user interface affordance on the display device; and
assigning the state associated with the user selection to the status attribute.

10. The system of claim 9, wherein the touch contact input includes a vertical touch gesture, and wherein the invoking of the user interface affordance further comprises displaying the user interface affordance on the display device.

11. The system of claim 10, wherein the user interface affordance is completely displayed subsequent to the vertical touch gesture reaching or exceeding a threshold distance away from an initial touch contact location.

12. The system of claim 10, wherein the user interface affordance is gradually displayed as a function of a distance the vertical touch gesture moves away from an initial touch contact location.

13. The system of claim 10, wherein the visual indication of the plurality of states includes an animation of each of the plurality of states moving as a function of a distance the vertical touch gesture moves away from an initial touch contact location.

14. The system of claim 9, wherein the process further comprises detecting an end of the touch contact input via the touch-sensitive input device, wherein the providing of the visual confirmation of the user selection occurs in response to the end of the touch contact input.

15. The system of claim 14, wherein the visual confirmation includes an animation.

16. A non-transient computer program product having instructions encoded thereon that when executed by one or more processors cause a process to be carried out, the process comprising:
invoking a user interface affordance in response to a touch contact input via a touch-sensitive input device, the touch contact input associated with an image displayed on a display device, the image having a status attribute associated therewith, the status attribute representing one of a plurality of states, the user interface affordance configured to provide a visual indication of the plurality of states on the display device;
receiving a user selection of one of the plurality of states via the user interface affordance based on the same touch contact input;
causing a visual confirmation of the user selection via the user interface affordance on the display device; and
assigning the state associated with the user selection to the status attribute.

17. The computer program product of claim 16, wherein the invoking of the user interface affordance further comprises displaying the user interface affordance on the display device.

18. The computer program product of claim 16, wherein the touch contact input includes a swipe touch gesture.

19. The computer program product of claim 16, wherein the touch contact input includes a flick touch gesture.

20. The computer program product of claim 19, wherein the user interface affordance is completely displayed subsequent to the flick touch gesture.
